(19) United States
(12) Patent Application Publication
(10) Pub. No.: US 2018/0215467 A1
(43) Pub. Date: Aug. 2, 2018

(54) Overhead Bin with Two Substantially Rigid Shelves

(71) Applicant: The Boeing Company, Chicago, IL (US)

(72) Inventors: Mithra M. Sankrithi, Lake Forest Park, WA (US); Richard K. Simms, Mukilteo, WA (US)

(21) Appl. No.: 15/419,367

(22) Filed: Jan. 30, 2017

(51) Int. Cl. B64D 11/00

(52) U.S. Cl. CPC B64D 11/003

(57) ABSTRACT

An overhead bin comprises a substantially rigid first shelf, bin sides, a substantially rigid second shelf above the first shelf, and a number of doors. The bin sides are connected to and extending upward from sides of the first shelf. The bin sides are connected to and extending upward from sides of the second shelf. The number of doors is configured to provide access to the first shelf and the second shelf from a first direction.

### BACKGROUND INFORMATION

### 1. Field

The present disclosure relates generally to storage of items and, in particular, to overhead storage of items. Still more particularly, the present disclosure relates to an apparatus for storing items in an overhead stowage bin in an aircraft.

### 2. Background

In commercial aviation, passengers may bring carryon items, such as luggage, into the passenger cabin. Passengers commonly bring roller bags into the passenger cabin. Luggage may be stored within a passenger cabin in storage areas. Storage areas in the passenger cabin include areas on the floor underneath the passenger seats and overhead compartments.

An overhead compartment may receive luggage when the overhead compartment is in an open state or open position. After luggage is placed into an overhead compartment, the overhead compartment may be placed into a closed state.

Many designs for overhead compartments exist. Some overhead compartment designs include a stationary luggage bin and a rotating door. Other overhead compartment designs include a rotating luggage bin. Yet other overhead compartment designs feature a luggage bin which is lowered into the passenger cabin.

With rising flight costs, passengers have decreased interest in checking their luggage to store below the cabin. Passengers are bringing a greater number of roller bags into the passenger cabin. Conventional overhead compartments have limited storage space.

Currently, overhead compartment space is not sufficient to accommodate a rolling bag per passenger on an aircraft. When overhead compartment space is full, rolling bags and other items that cannot be accommodated under passenger seats will be checked at the gate or once the passenger is on the aircraft. Checking luggage at the gate or on the aircraft may add undesirable time prior to take-off. Additionally, requiring a passenger to check a piece of luggage may reduce the passenger's satisfaction with the flying experience.

Therefore, it would be desirable to have a method and apparatus that takes into account at least some of the issues discussed above, as well as other possible issues.

### SUMMARY

In one illustrative embodiment, an overhead bin of an aircraft is presented. The overhead bin comprises a substantially rigid first shelf, bin sides, a substantially rigid second shelf above the first shelf, and a number of doors. The bin sides are connected to and extending upward from sides of the first shelf. The bin sides are connected to and extending upward from sides of the second shelf. The number of doors is configured to provide access to the first shelf and the second shelf from a first direction.

In another illustrative embodiment, an overhead bin of an aircraft is presented. The overhead bin comprises a first storage volume, a second storage volume, and a first door. The first storage volume is between a substantially rigid first shelf and a substantially rigid second shelf. The first storage volume has a first opening. The second storage volume is above the first storage volume. The second storage volume is between the second shelf and a top of the overhead bin. The second storage volume has a second opening. The first opening and the second opening are accessed from a same side of the aircraft. A first door is moveably covering the first opening.

In yet a further illustrative embodiment, an aircraft having overhead bins positioned only in a centerline region of the aircraft is presented. The aircraft comprises the overhead bins positioned only in the centerline region of the aircraft. Each overhead bin has a respective substantially rigid first shelf and a respective substantially rigid second shelf. The respective second shelf is above the respective first shelf. The overhead bins are positioned substantially between two aisles of a passenger cabin of the aircraft.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in which an illustrative embodiment may be implemented;

FIG. 2 is an illustration of a block diagram of a vehicle environment in accordance with an illustrative embodiment;

FIG. 3 is an illustration of an isometric cross-sectional view of overhead bins installed in a passenger cabin in an aircraft in accordance with an illustrative embodiment;

FIG. 4 is an illustration of a cross-sectional view of a first implementation of overhead bins installed in a passenger cabin in an aircraft in accordance with an illustrative embodiment;

FIG. 5 is an illustration of a cross-sectional view of another implementation of overhead bins installed in a passenger cabin in an aircraft in accordance with an illustrative embodiment;

FIG. 6 is an illustration of a cross-sectional view of another implementation of overhead bins installed in a passenger cabin in an aircraft in accordance with an illustrative embodiment;

FIG. 7 is an illustration of a cross-sectional view of another implementation of overhead bins installed in a passenger cabin in an aircraft in accordance with an illustrative embodiment;

FIG. 8 is an illustration of a cross-sectional view of another implementation of overhead bins installed in a passenger cabin in an aircraft in accordance with an illustrative embodiment;

FIG. 9 is an illustration of a cross-sectional view of another implementation of overhead bins installed in a passenger cabin in an aircraft in accordance with an illustrative embodiment;

FIG. 10 is an illustration of a cross-sectional view of another implementation of overhead bins installed in a passenger cabin in an aircraft in accordance with an illustrative embodiment;

FIG. 11 is an illustration of a cross-sectional view of another implementation of overhead bins installed in a passenger cabin in an aircraft in accordance with an illustrative embodiment;

FIG. 12 is an illustration of a block diagram of an aircraft manufacturing and service method in accordance with an illustrative embodiment; and

FIG. 13 is an illustration of a block diagram of an aircraft in which an illustrative embodiment may be implemented.

### DETAILED DESCRIPTION

The different illustrative embodiments recognize and take into account one or more different considerations. For example, the illustrative embodiments recognize and take into account that in the art of commercial airplanes that serve as airliners, there are several desirable conditions for overhead stowage bins in a passenger cabin. As an example, the illustrative embodiments recognize and take into account that it is desirable for overhead stowage bins to be spacious enough to accommodate at least one roller-bag (or equivalent size bag) per passenger. The illustrative embodiments also recognize and take into account that it is desirable for overhead stowage bins to be designed to be easily accessible and usable by passengers and crew with different strength, height and reach capabilities.

The illustrative embodiments also recognize and take into account that it is desirable for overhead stowage bins to be located with bottom surface sufficiently high to allow comfort for passengers seated under the bin. The illustrative embodiments further recognize and take into account that at least 58 to 62 inches above the cabin floor may be considered sufficiently high to allow comfort for passengers beneath the bin.

The illustrative embodiments recognize and take into account that it is desirable for overhead stowage bins to be aesthetically pleasing in conjunction with the cabin ceiling architecture and lighting architecture. The illustrative embodiments also recognize and take into account that it is desirable for overhead stowage bins to be capable of accommodating Passenger Service Units (PSUs) for passenger-usable reading lights and personal air outlets, as well as attendant call buttons and safety placards/lights (e.g., “fasten seat belts”).

The illustrative embodiments recognize and take into account that it is desirable to reduce weight in aircraft. Accordingly, the illustrative embodiments recognize and take into account that it is desirable for overhead stowage bins to be lighter weight than prior-art bins, such as translating or pivot bins.

The illustrative embodiments recognize and take into account that it is also desirable for overhead stowage bins to have a reduced cost including recurring and nonrecurring costs. The illustrative embodiments are intended to provide a better overall balanced achievement of the objectives described herein than any preceding solutions, especially for twin-aisle aircraft.

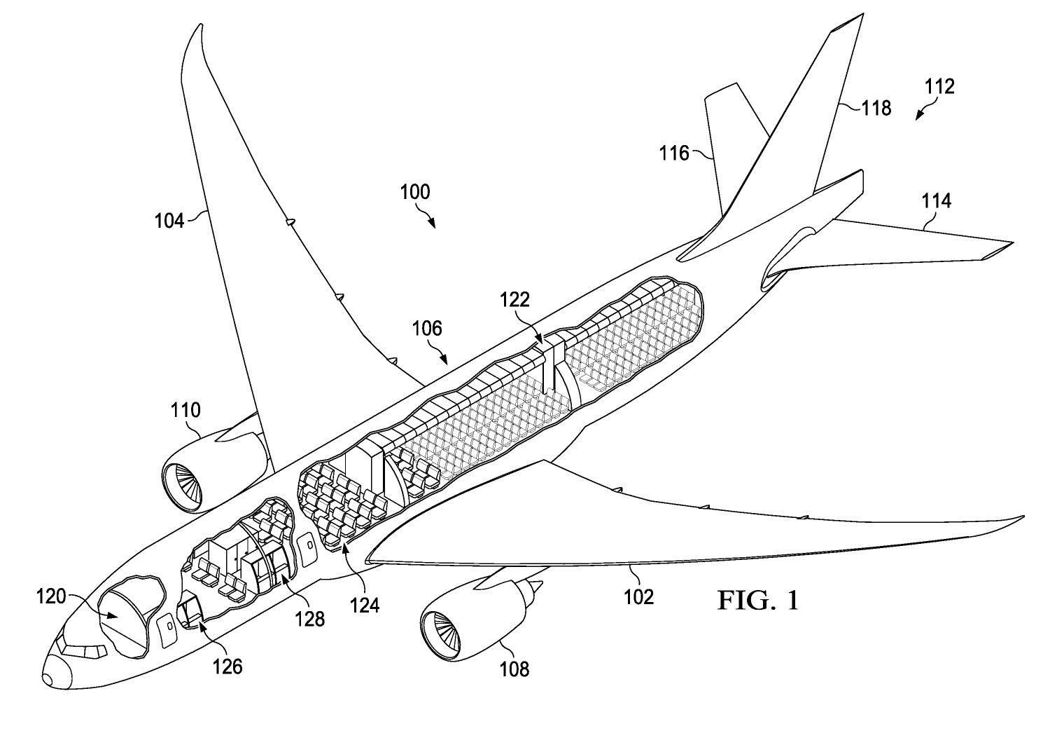

With reference now to the figures, and in particular, with reference to FIG. 1, an illustration of an aircraft is depicted in accordance with an illustrative embodiment. In this illustrative example, aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Body 106 also has cockpit 120 and passenger cabin 122. In this example, passenger cabin 122 may include passenger seating in seating area 124. Passenger seating may include a number of aircraft seats. As used herein, a “number of” items means one or more items. For example, a number of aircraft seats means one or more aircraft seats.

Further, seating area 124 in passenger cabin 122 may also include storage areas, such as a number of overhead compartments. Passenger cabin 122 also may include lavatory 126 and galley area 128. These two areas may be partitioned or separated from seating area 124 by a partitioning structure such as, for example, without limitation, a wall.

Protective removable covers, in accordance with an illustrative embodiment, may be used in aircraft 100 during manufacturing. For example, protective removable covers, in accordance with an illustrative embodiment, may be used to protect seats or other monuments in at least one of seating area 124, lavatory 126, or galley area 128.

As used herein, the phrase “at least one of,” when used with a list of items, means different combinations of one or more of the listed items may be used, and only one of each item in the list may be needed. In other words, “at least one of” means any combination of items and number of items may be used from the list but not all of the items in the list are required. The item may be a particular object, a thing, or a category.

For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A, one of item B, and ten of item C; four of item B and seven of item C; or other suitable combinations.

This illustration of aircraft 100 is provided for purposes of illustrating one environment in which the different illustrative embodiments may be implemented. The illustration of aircraft 100 in FIG. 1 is not meant to imply architectural limitations as to the manner in which different illustrative embodiments may be implemented. For example, aircraft 100 is shown as a commercial passenger aircraft. The different illustrative embodiments may be applied to other types of aircraft, such as private passenger aircraft, a rotorcraft, and other suitable types of aircraft. Also, other areas may be present in addition to seating area 124, lavatory 126, and galley area 128. Other areas may include, for example, without limitation, closets, storage areas, lounges, and other suitable areas for passenger seating. As another example, airplane seats within seating area 124 may be arranged differently from the depicted example. In other illustrative embodiments, some seats may be grouped into sets of single seats instead of three seats or pairs of seats as illustrated in seating area 124.

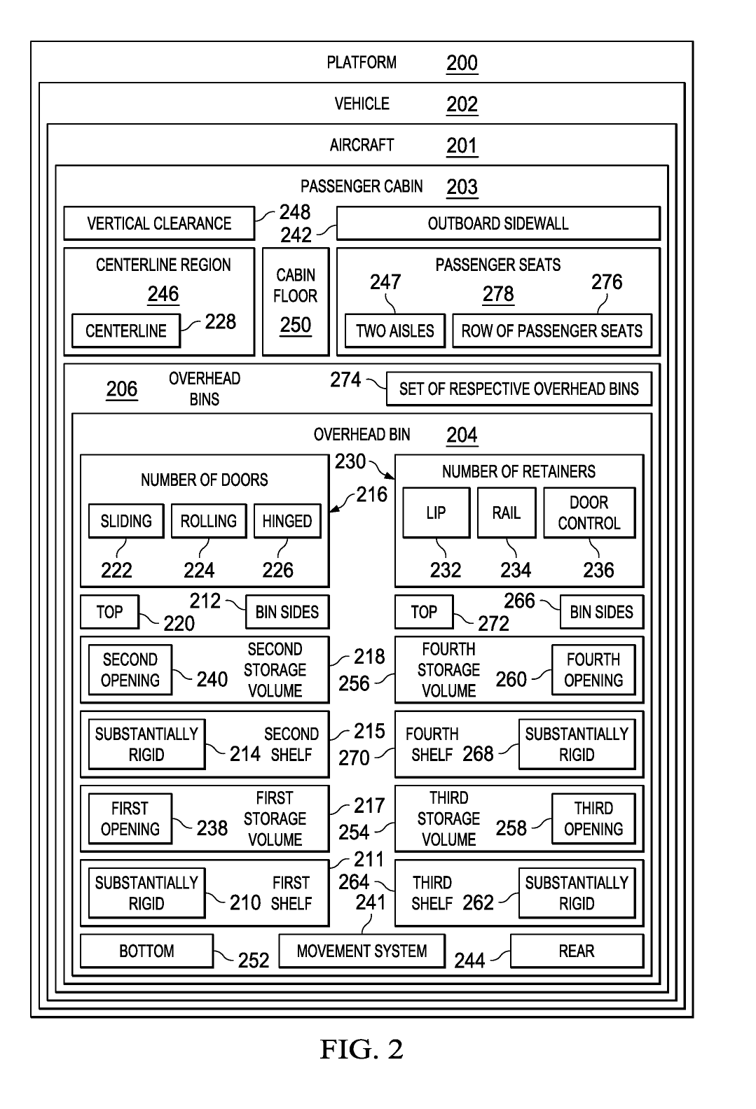

Turning now to FIG. 2, an illustration of a block diagram of a vehicle environment is depicted in accordance with an illustrative embodiment. In FIG. 2, platform 200 may be one implementation of aircraft 100 in FIG. 1.

As depicted, platform 200 has passenger cabin 203 with overhead bin 204. Overhead bin 204 is one of overhead bins 206. In some illustrative examples, platform 200 is aircraft 201.

Overhead bin 204 of aircraft 201 includes substantially rigid 210 first shelf 211, bin sides 212, substantially rigid 214 second shelf 215, and number of doors 216. Bin sides 212 are connected to and extending upward from sides of first shelf 211. Substantially rigid 214 second shelf 215 is above first shelf 211. Bin sides 212 are connected to and extending upward from sides of second shelf 215. Number of doors 216 is configured to provide access to first shelf 211 and second shelf 215 from a first direction. Second shelf 215 is longer than first shelf 211.

First shelf 211 is substantially rigid 210 based on at least one of material or design. For example, first shelf 211 does not move substantially relative to the remainder of overhead bin 204. First shelf 211 is fixed relative to the remainder of overhead bin 204.

Second shelf 215 is substantially rigid 214 based on at least one of material or design. For example, second shelf 215 does not move substantially relative to the remainder of overhead bin 204. Second shelf 215 is fixed relative to the remainder of overhead bin 204.

First storage volume 217 is a volume between first shelf 211 and second shelf 215. Second storage volume 218 is a volume between second shelf 215 and top 220 of overhead bin 204. In some illustrative examples, the volume between first shelf 211 and second shelf 215 is configured to receive a first number of roller bags, and the volume between second shelf 215 and top 220 of overhead bin 204 is configured to receive a second number of roller bags.

Roller bags are manufactured in a variety of sizes. Each airline sets a maximum allowable size for checked and carryon items. Roller bag dimensions are described as length X width X depth. The length is the distance from the handle to the wheels. The width is across the zippered face. The depth is from the zippered face towards the back of the luggage. Although it is not standardized, a depth of nine inches is considered a maximum depth for carry-ons for many airlines.

When first storage volume 217 is configured to receive a first number of roller bags, first storage volume 217 has a height between first shelf 211 and second shelf 215 of at least nine inches. When second storage volume 218 is configured to receive a second number of roller bags, second storage volume 218 between second shelf 215 and top 220 is at least nine inches. A height of nine inches accommodates many carry-on roller bags in a flat longitudinal orientation or a flat transverse orientation.

In some illustrative examples, at least one of first storage volume 217 or second storage volume 218 is configured to accommodate roller bags in an on-edge orientation. An on-edge orientation is one of an on-edge transverse orientation or an on-edge longitudinal orientation. To accommodate a roller bag in an on-edge orientation, the height of the storage volume must be at least the width of the roller bag. Many airlines have a maximum width of fourteen inches for carry-on bags.

When first storage volume 217 is configured to receive a first number of roller bags in an on-edge orientation, first storage volume 217 has a height between first shelf 211 and second shelf 215 of at least fourteen inches. When second storage volume 218 is configured to receive a second number of roller bags in an on-edge orientation, second storage volume 218 between second shelf 215 and top 220 is at least fourteen inches.

In some illustrative examples, roller bags may be stored in first storage volume 217 and second storage volume 218 in the same orientation. In other illustrative examples, roller bags may be stored in first storage volume 217 and second storage volume 218 in different orientations.

Number of doors 216 includes any desirable type of door. Number of doors 216 is selected from at least one of sliding 222, rolling 224, or hinged 226. In some illustrative examples, number of doors 216 includes at least one rolling door. When number of doors 216 is rolling 224, a portion of a respective door of number of doors 216 moves relative to the remainder of the respective door. When number of doors 216 is rolling 224, number of doors 216 is at least one of flexible, a plurality of panels, or a plurality of slats. For example, number of doors 216 may be formed of a flexible metal that bends such that a door of number of doors 216 changes shape when moving.

In some illustrative examples, number of doors 216 includes at least one sliding door. When number of doors 216 is sliding 222, number of doors 216 does not change length. Instead, number of doors 216 slides relative to the remainder of overhead bin 204.

In some illustrative examples, number of doors 216 comprises a first hinged door configured to provide access to first shelf 211 and a second hinged door configured to provide access to second shelf 215. When number of doors 216 is hinged 226, number of doors 216 swings relative to the remainder of overhead bin 204.

In some illustrative examples, first shelf 211 and second shelf 215 are substantially planar to a floor of passenger cabin 203. In some illustrative examples, at least one of first shelf 211 or second shelf 215 slopes downward in an outward direction relative to centerline 228 of aircraft 201. When at least one of first shelf 211 or second shelf 215 slopes downward in an outward direction, stowing items on the sloped shelf may be easier than stowing an item on a planar shelf. For example, when a shelf slopes downward in an outward direction relative to centerline 228, an edge of the shelf is lower within passenger cabin 203 than a planar shelf. Having a lower edge reduces the work a passenger performs to stow an item. For example, a lower edge allows a passenger to lift the item a shorter distance.

In other illustrative examples, at least one of first shelf 211 or second shelf 215 slopes downward in an inward direction relative to centerline 228 of aircraft 201. When at least one of first shelf 211 or second shelf 215 slopes downward in an inward direction relative to centerline 228, the slope of the shelf aids in retaining items within overhead bin 204.

In some illustrative examples, number of retainers 230 is associated with at least one of first shelf 211 or second shelf 215, wherein number of retainers 230 is configured to discourage items from falling from overhead bin 204. Number of retainers 230 takes any desirable form. Number of retainers 230 may be selected from at least one of lip 232, rail 234, or door control 236. When number of retainers 230 takes the form of door control 236, door control 236 may activate number of doors 216, in addition to discouraging items from falling from overhead bin 204. Door control 236 controls movement of number of doors 216. Door control 236 may take any desirable mechanical or electrical form. The control means may include at least one of a button, a switch, a latch, a control pad, a touchless control sensor, or any other desirable means for controlling a bin door.

In one illustrative example, overhead bin 204 of aircraft 201 comprises first storage volume 217 between substantially rigid 210 first shelf 211 and substantially rigid 214 second shelf 215, second storage volume 218 above first storage volume 217, and a first door. First storage volume 217 has first opening 238. Second storage volume 218 is between second shelf 215 and top 220 of overhead bin 204. Second storage volume 218 has second opening 240. First opening 238 and second opening 240 are accessed from a same side of aircraft 201. The first door is moveably covering first opening 238. In this example, number of doors 216 includes the first door.

In one example, overhead bin 204 further comprises a second door moveably covering second opening 240. When the second door is present, the first door is hinged 226. In other examples, a second door is not present. In these examples, the first door moveably covers second opening 240.

In some illustrative examples, overhead bin 204 also includes movement system 241 associated with at least one of first shelf 211 or second shelf 215. Movement system 241 is configured to reduce frictional resistance associated with bag loading and unloading to overhead bin 204. In some illustrative examples, movement system 241 comprises at least one of a roller, a roller tray, a powered roller, a wheel, a low-friction shelf surface, a low-friction shelf liner, or a shelf surface incorporating a low-friction material. When placing an item onto first shelf 211 or second shelf 215, movement of the item into overhead bin 204 may be aided by movement system 241.

In some illustrative examples, overhead bin 204 is associated with outboard sidewall 242. When overhead bin 204 is associated with outboard sidewall 242, overhead bin 204 may be referred to as an outboard overhead bin. In these illustrative examples, rear 244 of overhead bin 204 is formed by outboard overhead bin.

In these illustrative examples, another overhead bin (not depicted) of overhead bins 206 is associated with outboard sidewall 242 on an opposite side of passenger cabin 203. In these illustrative examples, none of overhead bins 206 are associated with centerline 228 of passenger cabin 203.

In other illustrative examples, overhead bins 206 are positioned only in centerline region 246 of aircraft 201. In these illustrative examples, none of overhead bins 206 are positioned on outboard sidewall 242. When overhead bin 204 is positioned in centerline region 246, overhead bin 204 is referred to as a centerline bin. Overhead bins 206 are positioned substantially between two aisles 247 of passenger cabin 203 of aircraft 201.

When overhead bins 206 are positioned only in centerline region 246 of aircraft 201, vertical clearance 248 between cabin floor 250 and bottom 252 of overhead bins 206 is at least 58 inches. Bottom 252 of overhead bins 206 may be formed by first shelf 211, passenger support units, or other components closest to cabin floor 250.

When overhead bins 206 are positioned only in centerline region 246, overhead bin 204 further includes third storage volume 254 and fourth storage volume 256. In some illustrative examples, at least one of first storage volume 217, second storage volume 218, third storage volume 254, or fourth storage volume 256 is configured to accommodate a roller bag in at least one of a flat longitudinal orientation, an on-edge transverse orientation, a flat transverse orientation or an on-edge longitudinal orientation.

In these illustrative examples, rear 244 of first storage volume 217 and second storage volume 218 is also rear 244 for third storage volume 254 and fourth storage volume 256. Third storage volume 254 has third opening 258. Fourth storage volume 256 has fourth opening 260. Third opening 258 and fourth opening 260 are accessed from a side of aircraft 201 opposite the side of aircraft 201 accessing first opening 238 and second opening 240.

Overhead bin 204 of aircraft 201 includes substantially rigid 262 third shelf 264, bin sides 266, substantially rigid 268 fourth shelf 270, and number of doors 216. Bin sides 266 are connected to and extending upward from sides of third shelf 264. Substantially rigid 268 fourth shelf 270 is above third shelf 264. Bin sides 266 are connected to and extending upward from the sides of fourth shelf 270. Number of doors 216 is configured to provide access to third shelf 264 and fourth shelf 270 from a second direction. Fourth shelf 270 is longer than third shelf 264.

Third shelf 264 is substantially rigid 262 based on at least one of material or design. For example, third shelf 264 does not move substantially relative to the remainder of overhead bin 204. Third shelf 264 is fixed relative to the remainder of overhead bin 204.

Fourth shelf 270 is substantially rigid 268 based on at least one of material or design. For example, fourth shelf 270 does not move substantially relative to the remainder of overhead bin 204. Fourth shelf 270 is fixed relative to the remainder of overhead bin 204.

Third storage volume 254 is a volume between third shelf 264 and fourth shelf 270. Fourth storage volume 256 is a volume between fourth shelf 270 and top 272 of overhead bin 204. In some illustrative examples, the volume between third shelf 264 and fourth shelf 270 is configured to receive a third number of roller bags, and the volume between fourth shelf 270 and top 272 of overhead bin 204 is configured to receive a fourth number of roller bags.

In some illustrative examples, first shelf 211 and third shelf 264 are substantially the same. In these illustrative examples, second shelf 270, and fourth shelf 270 are also substantially the same. Thus, overhead bin 204 is symmetrical about a centerline of overhead bin 204.

Set of respective overhead bins 274 substantially aligned with row of passenger seats 276 is configured to accommodate at least one roller bag per seat in row of passenger seats 276. Set of respective overhead bins 274 substantially aligned with row of passenger seats 276 includes either overhead bin 204 positioned only within centerline region 246 or overhead bin 204 associated with outboard sidewall 242 and another overhead bin (not depicted) associated with outboard sidewall 242 on an opposite side of passenger cabin 203.

The illustration of overhead bins 206 of aircraft 201 in FIG. 2 is not meant to imply physical or architectural limitations to the manner in which an illustrative embodiment may be implemented. Other components, in addition to or in place of the ones illustrated, may be used. Some components may be unnecessary. Also, the blocks are presented to illustrate some functional components. One or more of these blocks may be combined, divided, or combined and divided into different blocks when implemented in an illustrative embodiment.

For example, row of passenger seats 276 is only a subset of passenger seats 278 present in passenger cabin 203. Although not depicted, overhead bins 206 may include at least one respective overhead bin for each respective row of seats of passenger sets 278.

Further, in some illustrative examples, overhead bin 204 does not have third storage volume 254 and fourth storage volume 256. For example, when overhead bin 204 is associated with outboard sidewall 242, overhead bin 204 only has first storage volume 217 and second storage volume 218.

Further, although not depicted, overhead bins 206 includes more than just overhead bin 204. For example, overhead bins 206 includes additional overhead bins following overhead bin 204, moving in the direction of the length of aircraft 201. In another example, when overhead bin 204 is associated with outboard sidewall 242, an additional overhead bin 204 will service row of passenger seats 276 on an opposite side of centerline 228 on outboard sidewall 242.

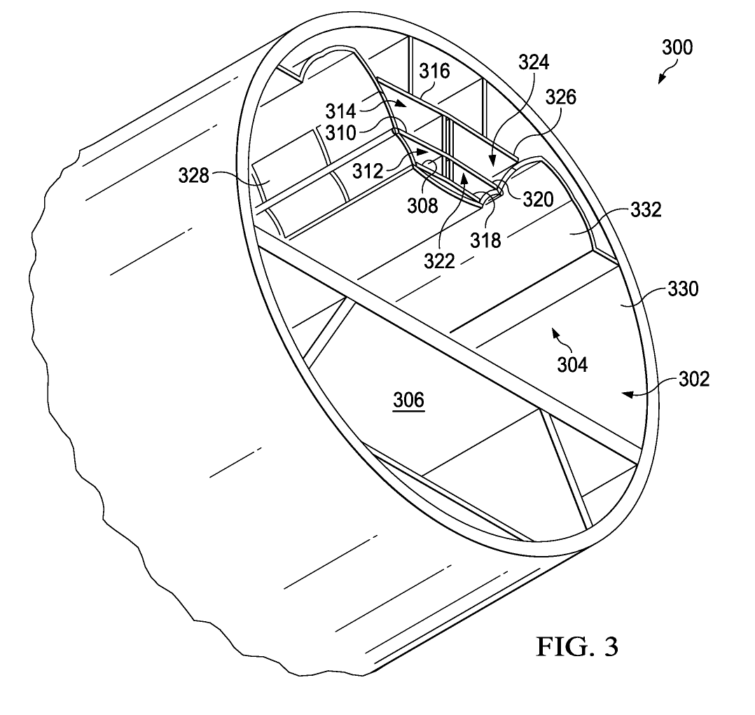

Turning now to FIG. 3, an illustration of an isometric cross-sectional view of overhead bins installed in a passenger cabin in an aircraft is depicted in accordance with an illustrative embodiment. Aircraft 300 has passenger cabin 302 with overhead bins 304. Aircraft 300 is one physical implementation of aircraft 201 of FIG. 2. FIG. 3 is an isometric cross-sectional view of aircraft 100 of FIG. 1. Cargo container 306 is located below passenger cabin 302.

Overhead bins 304 are physical implementations of overhead bins 206 of FIG. 2. FIG. 3 is a cross-sectional view through overhead bin 306 of overhead bins 304. Overhead bin 306 has first shelf 308 and second shelf 310. Second shelf 310 is positioned over first shelf 308. First storage volume 312 is between first shelf 308 and second shelf 310. Second storage volume 314 is between second shelf 310 and top 316 of overhead bin 306. Luggage or other items are placed into first storage volume 312 or second storage volume 314 from the same side of aircraft 300.

Overhead bin 306 also includes third shelf 318 and fourth shelf 320. Fourth shelf 320 is positioned over third shelf 318. Third storage volume 322 is between third shelf 318 and fourth shelf 320. Fourth storage volume 324 is between fourth shelf 320 and top 326 of overhead bin 306. Luggage or other items are placed into third storage volume 322 and fourth storage volume 324 from the same side of the aircraft 300. Third storage volume 322 and fourth storage volume 324 are accessed from an opposite side of aircraft 300 than first storage volume 312 and second storage volume 314. In some illustrative examples, third shelf 318 and fourth shelf 320 may be described as being part of a separate overhead bin from first shelf 308 and second shelf 310.

As depicted, surfaces 328 of overhead bins 304 are concave. Surfaces 328 are formed at least partially by a plurality of doors. By surfaces 328 being concave, aesthetically passenger cabin 302 appears to be more spacious. Lighting may be combined with the concave nature of surfaces 328 to affect the aesthetics of passenger cabin 302.

In one illustrative example, overhead bin 306 is configured with a lower bin hinged door similar to and complemented by an upper bin roll-up door. The lower bin hinged door would moveably cover first storage volume 312 while upper bin roll-up door would moveably cover second storage volume 314.

Passenger cabin 302 also has outboard sidewall 330. Outboard sidewall 330 has a small installation for Passenger Service Units (PSUs), and optionally small personal stowage, for items such as a folding umbrella or a small purse. In some illustrative examples, upper portion 332 of outboard sidewall 330 has a smooth surface suitable for receiving projected images. For example, short-throw projectors can be used to present soothing images such as starry skies, sunny skies, cloudy skies, mood lighting images, or other soothing images and/or message or advertising images.

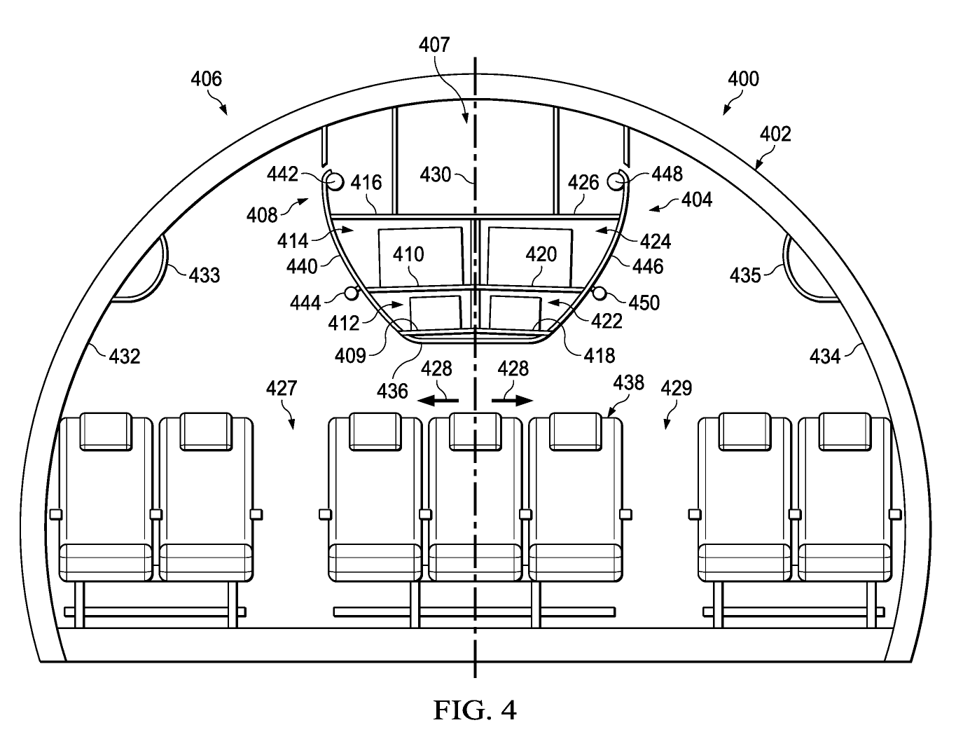

FIGS. 4-12 each depict implementations of overhead bins having a substantially rigid first shelf and a substantially rigid second shelf above the first shelf. Each of FIGS. 4-12 depicts a non-limiting illustrative example of how at least one overhead bin may be implemented.

Turning now to FIG. 4, an illustration of a cross-sectional view of a first implementation of overhead bins installed in a passenger cabin in an aircraft is depicted in accordance with an illustrative embodiment. Aircraft 400 has passenger cabin 402 with overhead bins 404. Aircraft 400 is one physical implementation of aircraft 201 of FIG. 2. FIG. 4 is an isometric cross-sectional view of aircraft 100 of FIG. 1. View 406 does not contain a cargo container or other structures below passenger cabin 402.

Aircraft 400 has overhead bins 404 positioned only in centerline region 407 of aircraft 400. Each overhead bin has a respective substantially rigid first shelf and a respective substantially rigid second shelf. The respective second shelf is above the respective first shelf. Overhead bins 404 are positioned substantially between two aisles of passenger cabin 402 of aircraft 400.

Overhead bin 408 is one of overhead bins 404. Overhead bin 408 is the bin cut through in cross-section in view 406 of FIG. 4.

Overhead bin 408 is a physical implementation of overhead bin 204 of FIG. 2. Overhead bin 408 has first shelf 409 and second shelf 410. Second shelf 410 is positioned over first shelf 409. Second shelf 410 is longer than first shelf 409. First storage volume 412 is between first shelf 409 and second shelf 410. Second storage volume 414 is between second shelf 410 and top 416 of overhead bin 408. Luggage or other items are placed into first storage volume 412 or second storage volume 414 from the same side of aircraft 400.

Overhead bin 408 also includes third shelf 418 and fourth shelf 420. Fourth shelf 420 is positioned over third shelf 418. Fourth shelf 420 is longer than third shelf 418. Third storage volume 422 is between third shelf 418 and fourth shelf 420. Fourth storage volume 424 is between fourth shelf 420 and top 426 of overhead bin 408. Luggage or other items are placed into third storage volume 422 and fourth storage volume 424 from the same side of the aircraft 400. For example, first storage volume 412 and second storage volume 414 may be accessed from aisle 427. Third storage volume 422 and fourth storage volume 424 are accessed from an opposite side of aircraft 400 than first storage volume 412 and second storage volume 414. For example, third storage volume 422 and fourth storage volume 424 may be accessed from aisle 429. In some illustrative examples, third shelf 418 and fourth shelf 420 may be described as being part of a separate overhead bin from first shelf 409 and second shelf 410.

As depicted, first shelf 409, second shelf 410 third shelf 418, and fourth shelf 420 each slope downward in outward direction 428 relative to centerline 430 of aircraft 400. The slope downward may aid passengers and aircraft personnel in placing items onto first shelf 409, second shelf 410 third shelf 418, or fourth shelf 420.

Aircraft 400 has outboard side wall 432 with passenger service unit 433 and outboard side wall 434 with passenger service unit 435. Passenger service unit 436 for center seats 438 is positioned beneath first shelf 409 and third shelf 418.

As depicted, first door 440 moveably covers first storage volume 412. First door 440 also moveably covers second storage volume 414. In this implementation, first door 440 is a rolling door. When desired, first door 440 is moved using door rotation roller 442 to access at least one of first storage volume 412 or second storage volume 414. Movement of first door 440 may be controlled using a controller. In some illustrative examples, a controller may be associated with hand rail 444.

Hand rail 444 may be used by passengers and aircraft personnel for maneuvering within passenger cabin 402. Hand rail 444 also serves as a lip for inhibiting upper bin contents from falling out of second storage volume 414 when first door 440 is open, and when aircraft 400 is maneuvering or flying through turbulence.

When one component is “associated” with another component, the association is a physical association in the depicted examples. For example, a first component may be considered to be associated with a second component by being secured to the second component, bonded to the second component, mounted to the second component, welded to the second component, fastened to the second component, and/or connected to the second component in some other suitable manner. The first component also may be connected to the second component using a third component. The first component may also be considered to be associated with the second component by being formed as part of and/or an extension of the second component.

As depicted, second door 446 moveably covers third storage volume 422. First door 440 also moveably covers and fourth storage volume 424. In this implementation, second door 446 is a rolling door. When desired, second door 446 is moved using door rotation roller 448 to access at least one of third storage volume 422 or fourth storage volume 424. Movement of second door 446 may be controlled using a controller. In some illustrative examples, a controller may be associated with hand rail 450.

Hand rail 450 may be used by passengers and aircraft personnel for maneuvering within passenger cabin 402. Hand rail 450 also serves as a lip for inhibiting upper bin contents from falling out of fourth storage volume 424 when second door 446 is open, and when aircraft 400 is maneuvering or flying through turbulence.

Overhead bin 408 as implemented is present in an airliner with a representative twin-aisle, seven-abreast, economy seating cross-sectional configuration. Whereas a twin aisle configuration is typically fitted, conventionally, with both outboard bins above the outer seating units and center bins above the center seating units, with the outboard and center bins being of pivot, shelf, or translating bin types. As depicted in this implementation, no outboard bins are present. FIG. 4 has large center bins arranged in a two-deep stacked shelf arrangement. This implementation provides more bin volume, reduced weight and cost impacts, and a more open outboard ceiling architecture than conventional designs.

The illustration of overhead bin 408 of aircraft 400 in FIG. 4 is not meant to imply physical or architectural limitations to the manner in which an illustrative embodiment may be implemented. Other components, in addition to or in place of the ones illustrated, may be used. Some components may be unnecessary.

For example, in some illustrative examples, the bin opening control may be positioned somewhere other than hand rail 444 or hand rail 450. In another illustrative example, hand rail 444 or hand rail 450 may not be present.

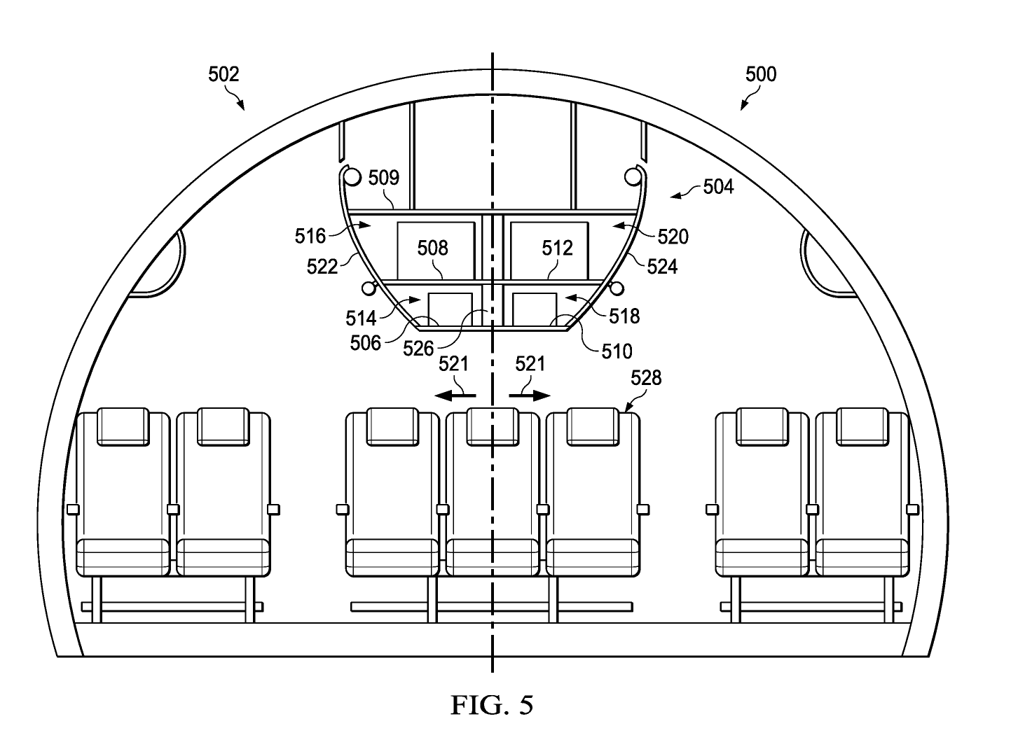

Turning now to FIG. 5, an illustration of a cross-sectional view of another implementation of overhead bins installed in a passenger cabin in an aircraft is depicted in accordance with an illustrative embodiment. Aircraft 500 is a physical implementation of aircraft 201 of FIG. 2. Aircraft 500 may be the same as aircraft 100 of FIG. 1. In aircraft 500, layout 502 of overhead bin 504 is substantially similar to overhead bin 408 of FIG. 4. The differences between overhead bin 504 and overhead bin 408 of FIG. 4 are detailed below.

As depicted, overhead bin 504 includes substantially rigid first shelf 506, substantially rigid second shelf 508, top 509, substantially rigid third shelf 510, substantially rigid fourth shelf 512, and top 513 forming first storage volume 514, second storage volume 516, third storage volume 518, and fourth storage volume 520. In overhead bin 504, first shelf 506, second shelf 508, third shelf 510, and fourth shelf 512 are substantially planar. First shelf 506, second shelf 508, third shelf 510, and fourth shelf 512 are substantially not sloped moving in outward direction 521.

When first shelf 506 and third shelf 510 are substantially planar, better head room results for the center passengers seated below overhead bin 504. From a human factors perspective, a clearance for high comfort for a tall seated person in a seat below the bottom of overhead bin 504 is desirably between 58 and 62 inches, without limitation. In one non-limiting example, when first shelf 506, second shelf 508, third shelf 510, and fourth shelf 512 are substantially planar, the nominal clearance is just over 60 inches between the cabin floor and the lower surface of overhead bin 504.

Overhead bin 504 has first door 522 moveably covering first storage volume 514 and second storage volume 516. Overhead bin 504 has second door 524 moveably covering third storage volume 518 and fourth storage volume 520. As depicted, both first door 522 and second door 524 are rolling doors.

Passenger service unit 526 has been shifted from the location of passenger service unit 436 of FIG. 4. As depicted, passenger service unit 526 for center seats 528 is positioned between first storage volume 514 and second storage volume 516.

FIG. 5 is not a limiting example of implementations for overhead bin 504 with two substantially rigid shelfs. Although FIG. 5 is depicted as having two pairs of opposite facing volumes, in some illustrative examples, there may be a storage volume accessible using both first door 522 and second door 524.

For example, in one implementation, second storage volume 516 and fourth storage volume 520 are not separated by rear faces. Instead, in this implementation, second shelf 508 and fourth shelf 512 are a single shelf forming a single storage volume accessible by both first door 522 and second door 524. In another implementation, first storage volume 514 and third storage volume 518 are not separated by rear faces. Instead, in this implementation, first shelf 506 and third shelf 510 are a single shelf forming a single storage volume accessible by both first door 522 and second door 524. In some illustrative examples, overhead bin 504 has two storage volumes accessible from both first door 522 and second door 524.

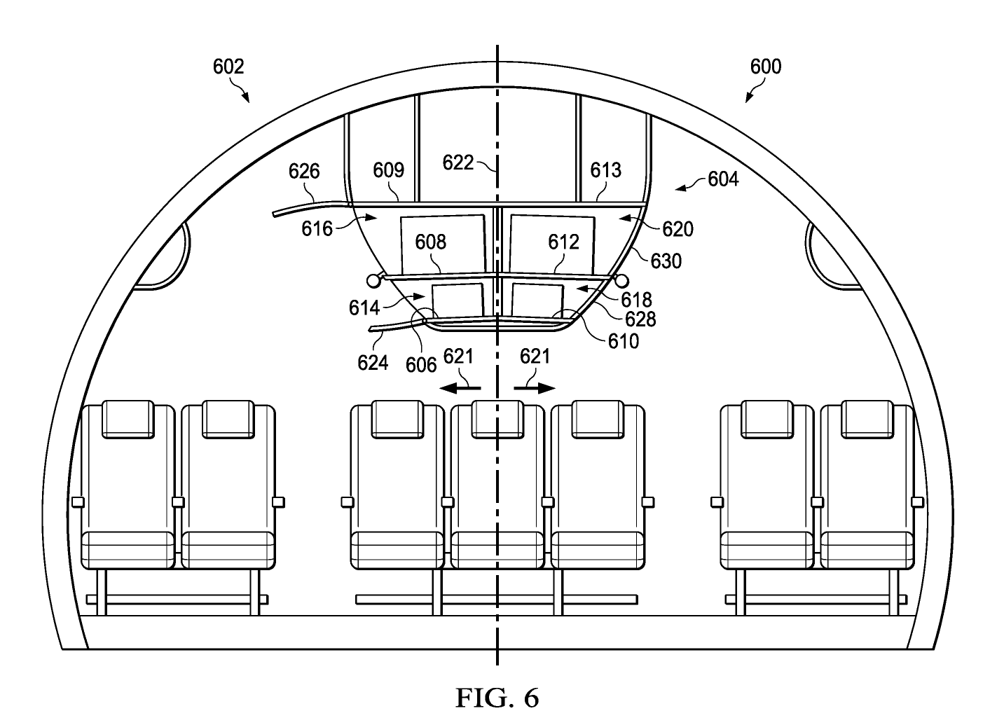

Turning now to FIG. 6, an illustration of a cross-sectional view of another implementation of overhead bins installed in a passenger cabin in an aircraft is depicted in accordance with an illustrative embodiment. Aircraft 600 is a physical implementation of aircraft 201 of FIG. 2. Aircraft 600 may be the same as aircraft 100 of FIG. 1. In aircraft 600, layout 602 of overhead bin 604 is substantially similar to overhead bin 408 of FIG. 4. The differences between overhead bin 604 and overhead bin 408 of FIG. 4 are detailed below.

As depicted, overhead bin 604 includes substantially rigid first shelf 606, substantially rigid second shelf 608, top 609, substantially rigid third shelf 610, substantially rigid fourth shelf 612, and top 613 forming first storage volume 614, second storage volume 616, third storage volume 618, and fourth storage volume 620. Like overhead bin 408, in overhead bin 604, first shelf 606, second shelf 608, third shelf 610, and fourth shelf 612 are sloped downward moving in outward direction 621 from centerline 622.

Unlike in overhead bin 408, overhead bin 604 has separate doors moveably covering first storage volume 614 and second storage volume 616. As depicted, first door 624 moveably covers first storage volume 614. Second door 626 moveably covers second storage volume 616. As depicted, first door 624 and second door 626 are hinged.

As depicted, a bin closure for first storage volume 614 and second storage volume 616 comprises clamshell optionally coupled bin doors, in lieu of the roll-up doors of FIG. 4. The clamshell doors may be manually or electrically operated in variant implementations, and may be uncoupled or mechanically coupled or electrically coupled.

Further unlike in overhead bin 408, overhead bin 604 has separate doors moveably covering third storage volume 618 and fourth storage volume 620. As depicted, third door 628 moveably covers third storage volume 618. Fourth door 630 moveably covers fourth storage volume 620. As depicted, third door 628 and fourth door 630 are hinged.

As depicted, bin closure for third storage volume 618 and fourth storage volume 620 comprises clamshell optionally coupled bin doors, in lieu of the roll-up doors of FIG. 4. The clamshell doors may be manually or electrically operated in variant implementations, and may be uncoupled or mechanically coupled or electrically coupled.

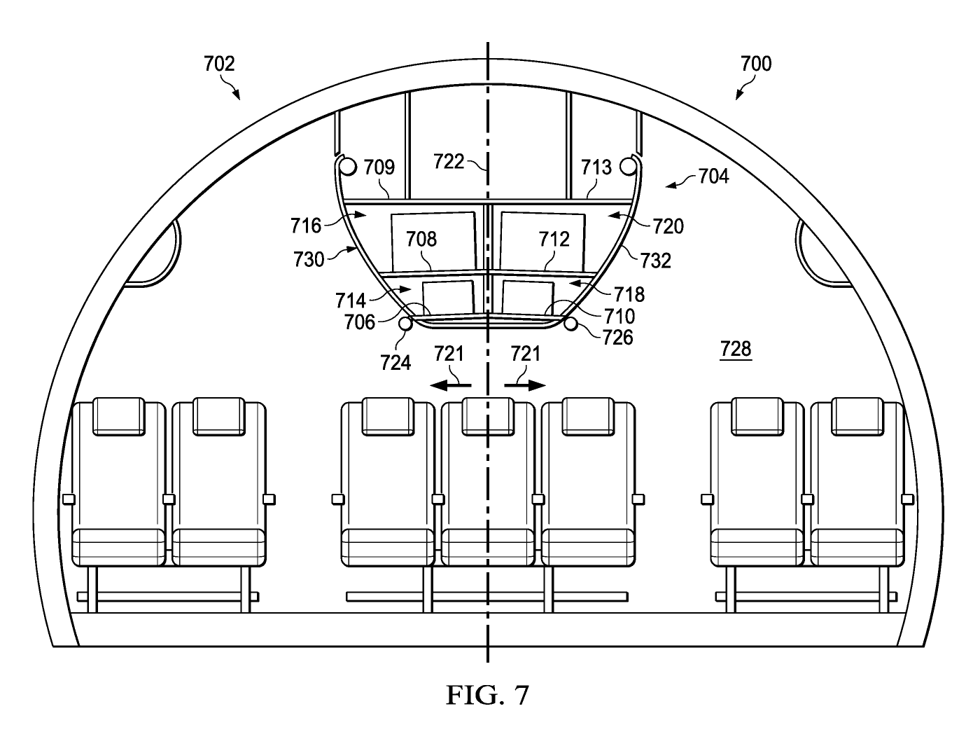

Turning now to FIG. 7, an illustration of a cross-sectional view of another implementation of overhead bins installed in a passenger cabin in an aircraft is depicted in accordance with an illustrative embodiment. Aircraft 700 is a physical implementation of aircraft 201 of FIG. 2. Aircraft 700 may be the same as aircraft 100 of FIG. 1. In aircraft 700, layout 702 of overhead bin 704 is substantially similar to overhead bin 408 of FIG. 4. The differences between overhead bin 704 and overhead bin 408 of FIG. 4 are detailed below.

As depicted, overhead bin 704 includes substantially rigid first shelf 706, substantially rigid second shelf 708, top 709, substantially rigid third shelf 710, substantially rigid fourth shelf 712, and top 713 forming first storage volume 714, second storage volume 716, third storage volume 718, and fourth storage volume 720. Like overhead bin 408, in overhead bin 704, first shelf 706, second shelf 708, third shelf 710, and fourth shelf 712 are sloped downward moving in outward direction 721 from centerline 722.

Unlike overhead bin 408, overhead bin 704 has hand rail 724 associated with first storage volume 714 and hand rail 726 associated with third storage volume 718. The hand rails have been moved from overhead bin 408 of FIG. 4 to a level at or below the lower bins, as illustrated.

Hand rail 724 may be used by passengers and aircraft personnel for maneuvering within passenger cabin 728. Hand rail 724 also serves as a lip for inhibiting lower bin contents from falling out of first storage volume 714 when first door 730 is open, and when aircraft 700 is maneuvering or flying through turbulence.

Hand rail 726 may be used by passengers and aircraft personnel for maneuvering within passenger cabin 728. Hand rail 726 also serves as a lip for inhibiting lower bin contents from falling out of third storage volume 718 when second door 732 is open, and when aircraft 700 is maneuvering or flying through turbulence.

In this illustrative example, bin operating controls are integrated in any desirable locations. For example, bin operating controls may be integrated into hand rail 724 and hand rail 726, as illustrated. As depicted, first door 730 and second door 732 are rolling doors. However, first door 730 and second door 732 may take any desirable form. Further, additional doors may be present in overhead bin 704.

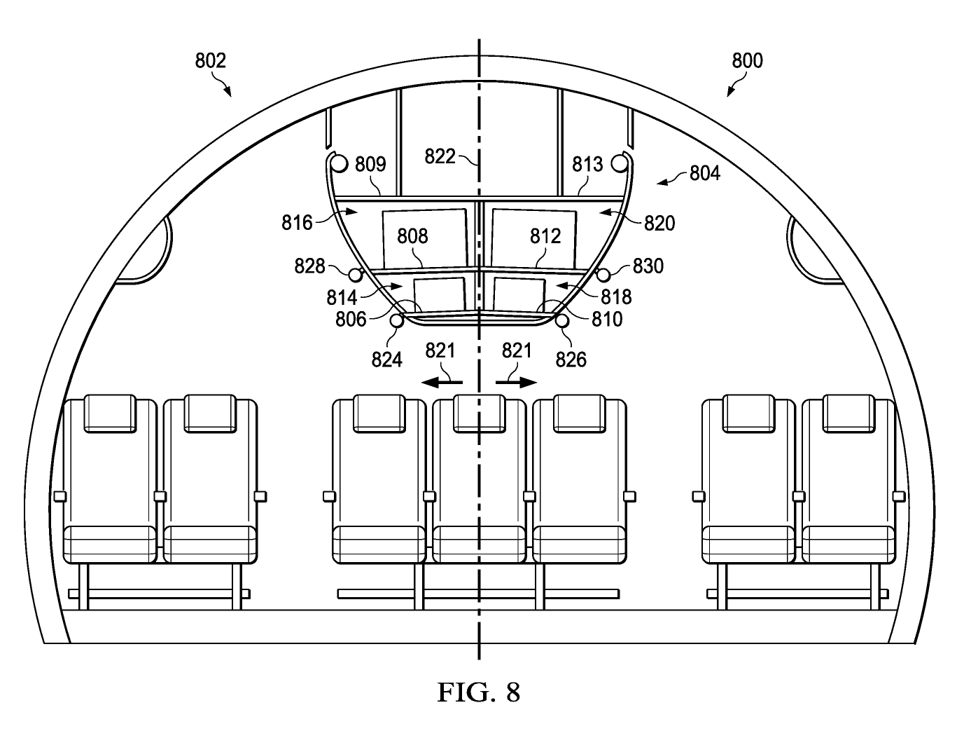

Turning now to FIG. 8, an illustration of a cross-sectional view of another implementation of overhead bins installed in a passenger cabin in an aircraft is depicted in accordance with an illustrative embodiment. Aircraft 800 is a physical implementation of aircraft 201 of FIG. 2. Aircraft 800 may be the same as aircraft 100 of FIG. 1. In aircraft 800, layout 802 of overhead bin 804 is substantially similar to overhead bin 408 of FIG. 4. The differences between overhead bin 804 and overhead bin 408 of FIG. 4 are detailed below.

As depicted, overhead bin 804 includes substantially rigid first shelf 806, substantially rigid second shelf 808, top 809, substantially rigid third shelf 810, substantially rigid fourth shelf 812, and top 813 forming first storage volume 814, second storage volume 816, third storage volume 818, and fourth storage volume 820. Like overhead bin 408, in overhead bin 804, first shelf 806, second shelf 808, third shelf 810, and fourth shelf 812 are sloped downward moving in outward direction 821 from centerline 822.

Unlike in overhead bin 408, overhead bin 804 has hand rail 824 associated with first storage volume 814 and hand rail 826 associated with third storage volume 818 in addition to hand rail 828 associated with second storage volume 816 and hand rail 830 associated with fourth storage volume 820. Each of hand rail 824, hand rail 826, hand rail 828, and hand rail 830 may serve as lips for inhibiting contents of respective storage volumes from falling out of overhead bin 804 when a respective bin door is open and when the aircraft is maneuvering or flying through turbulence.

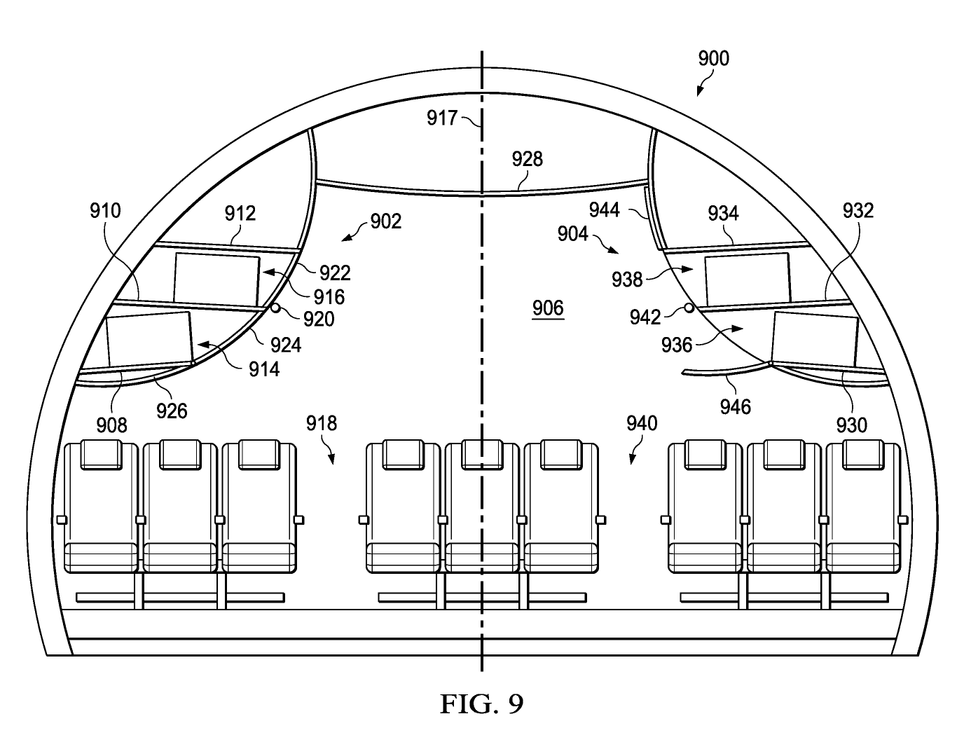

Turning now to FIG. 9, an illustration of a cross-sectional view of another implementation of overhead bins installed in a passenger cabin in an aircraft is depicted in accordance with an illustrative embodiment. Aircraft 900 is a physical implementation of aircraft 201 of FIG. 2. In some illustrative examples, although aircraft 100 of FIG. 1 is depicted as having centerline bins, aircraft 100 may instead have the same design as aircraft 900.

As depicted, aircraft 900 is an airliner with a representative twin-aisle, nine-abreast, economy seating cross-sectional configuration. Conventionally, a twin-aisle configuration is typically fitted, with both outboard bins above the outer seating units and center bins above the center seating units, with the outboard and center bins being shelf, pivot, or translating bin types. Aircraft 900 has no center bins but has large outboard bins arranged in a two-deep stacked arrangement.

Overhead bin 902 and overhead bin 904 allow for storage of luggage for all passengers without a center bin. Removal of a center bin may cause passenger cabin 906 to appear more spacious.

Overhead bin 902 is a physical implementation of overhead bin 204 of FIG. 2. Overhead bin 902 has substantially rigid first shelf 908, substantially rigid second shelf 910, and top 912 forming first storage volume 914 and second storage volume 916. Second shelf 910 is positioned over first shelf 908. Second shelf 910 is longer than first shelf 908.

As depicted, first shelf 908 is sloped downward in an outward direction relative to centerline 917 of aircraft 900. The downward slope towards the sidewall of aircraft 900 may aid in retention of items within first storage volume 914. As depicted, second shelf 910 is sloped upward in an outward direction relative to centerline 917 of aircraft 900. The slope upward towards the sidewall of aircraft 900 may aid passengers and airline personnel in placing items within second storage volume 916.

First storage volume 914 is between first shelf 908 and second shelf 910. Second storage volume 916 is between second shelf 910 and top 912 of overhead bin 902. Luggage or other items are placed into first storage volume 914 or second storage volume 916 from the same side of aircraft 900. For example, luggage or other items are placed into first storage volume 914 or second storage volume 916 from aisle 918.

Hand rail 920 may be used by passengers and aircraft personnel for maneuvering within passenger cabin 906. Hand rail 920 also serves as a lip for inhibiting upper bin contents from falling out of second storage volume 916 when first door 922 is open, and when aircraft 900 is maneuvering or flying through turbulence. As depicted, first door 922 may be a sliding or a hinged door. First door 922 moves independently of second door 924 moveably covering first storage volume 914. As depicted, second door 924 is a hinged door.

In some illustrative examples, first door 922 and second door 924 may be controlled by a same set of controls. In other illustrative examples, first door 922 and second door 924 may be controlled by different sets of controls. The controls for first door 922 and second door 924 may be positioned in any desirable location. In some illustrative examples, the controls for first door 922 and second door 924 may be associated with hand rail 920.

As depicted, first door 922, second door 924, and passenger service unit 926 below first shelf 908 are convex. Further, ceiling 928 of passenger cabin 906 is convex as depicted. In some illustrative examples, any of these components may be concave or planar.

Overhead bin 904 is a physical implementation of overhead bin 204 of FIG. 2. Overhead bin 904 has substantially rigid third shelf 930, substantially rigid fourth shelf 932, and top 934 forming third storage volume 936 and fourth storage volume 938. Fourth shelf 932 is positioned over third shelf 930. Fourth shelf 932 is longer than third shelf 930.

As depicted, third shelf 930 is sloped downward in an outward direction relative to centerline 917 of aircraft 900. The downward slope towards the sidewall of aircraft 900 may aid in retention of items within third storage volume 932. As depicted, fourth shelf 932 is sloped upward in an outward direction relative to centerline 917 of aircraft 900. The slope upward towards the sidewall of aircraft 900 may aid passengers and airline personnel in placing items within fourth storage volume 938.

Third storage volume 936 is between third shelf 930 and fourth shelf 932. Fourth storage volume 938 is between fourth shelf 932 and top 934 of overhead bin 904. Luggage or other items are placed into third storage volume 936 or fourth storage volume 938 from the same side of aircraft 900. For example, luggage or other items are placed into third storage volume 936 or fourth storage volume 938 from aisle 940.

Hand rail 942 may be used by passengers and aircraft personnel for maneuvering within passenger cabin 906. Hand rail 942 also serves as a lip for inhibiting upper bin contents from falling out of fourth storage volume 938 when third door 944 is open, and when aircraft 900 is maneuvering or flying through turbulence. As depicted, third door 944 may be a sliding or a hinged door. Third door 944 moves independently of fourth door 946 moveably covering third storage volume 936. As depicted, fourth door 946 is a hinged door.

In some illustrative examples, third door 944 and fourth door 946 may be controlled by a same set of controls. In other illustrative examples, third door 944 and fourth door 946 may be controlled by different sets of controls. The controls for third door 944 and fourth door 946 may be positioned in any desirable location. In some illustrative examples, the controls for third door 944 and fourth door 946 may be associated with hand rail 942. As depicted, third door 944, fourth door 946, and passenger service unit 926 below third shelf 930 are convex.

As depicted, first door 922 may be substantially the same as third door 944, but in a closed position. As depicted, second door 924 may be substantially the same as fourth door 946, but in a closed position.

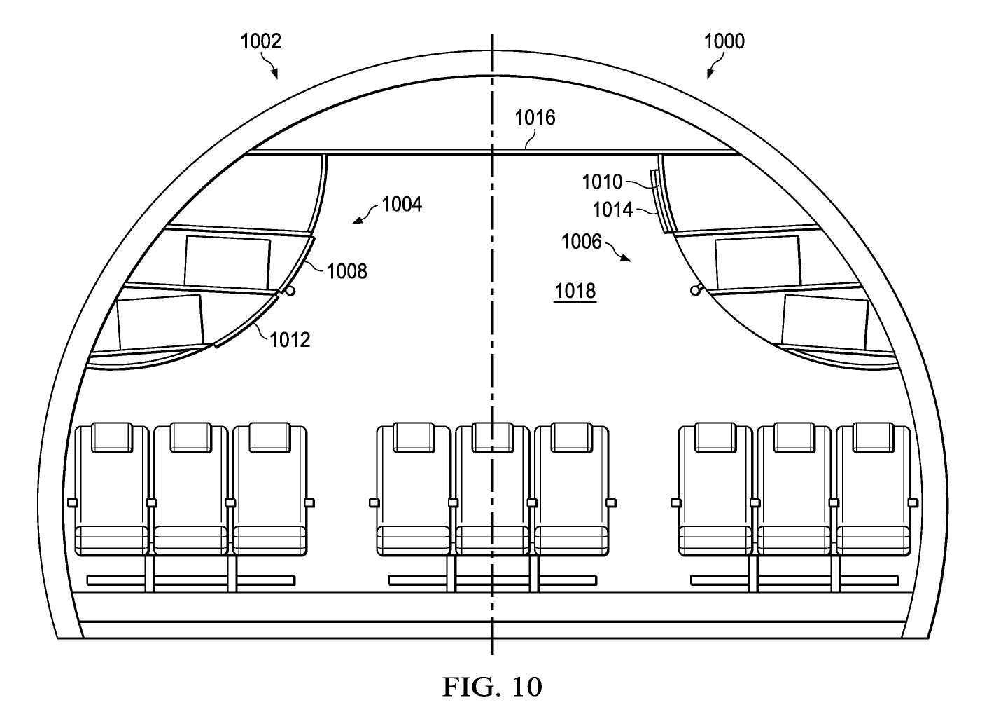

Turning now to FIG. 10, an illustration of a cross-sectional view of another implementation of overhead bins installed in a passenger cabin in an aircraft is depicted in accordance with an illustrative embodiment. Aircraft 1000 is a physical implementation of aircraft 201 of FIG. 2. In some illustrative examples, although aircraft 100 of FIG. 1 is depicted as having centerline bins, aircraft 100 may instead have the same design as aircraft 1000. In aircraft 1000, layout 1002 of overhead bin 1004 and overhead bin 1006 is substantially similar to overhead bin 902 and overhead bin 904 of FIG. 9. The differences between overhead bin 902 and overhead bin 904 of FIG. 9 and overhead bin 1004 and overhead bin 1006 are detailed below.

Overhead bin 1004 and overhead bin 1006 are depicted each with a 2-panel bin door that opens with the panels sliding one behind the other. Mechanical and/or electric opening and closing means may be provided, with weight counterbalancing optionally provided as well. Bin door controls may be associated with at least one of the lower bin space or the upper bin space.

As depicted, first door 1008 may be substantially the same as third door 1010, but in a closed position. As depicted, second door 1012 may be substantially the same as fourth door 1014, but in a closed position. The controls for first door 1008, second door 1012, third door 1010, and fourth door 1014 may be positioned in any desirable location. Further, the controls may take any desirable mechanical or electrical form.

In FIG. 10, ceiling 1016 of passenger cabin 1018 is substantially planar. Changing the shape of ceiling 1016 affects the aesthetics of passenger cabin 1018. When ceiling 1016 of passenger cabin 1018 is planar, passenger cabin 1018 may appear more spacious.

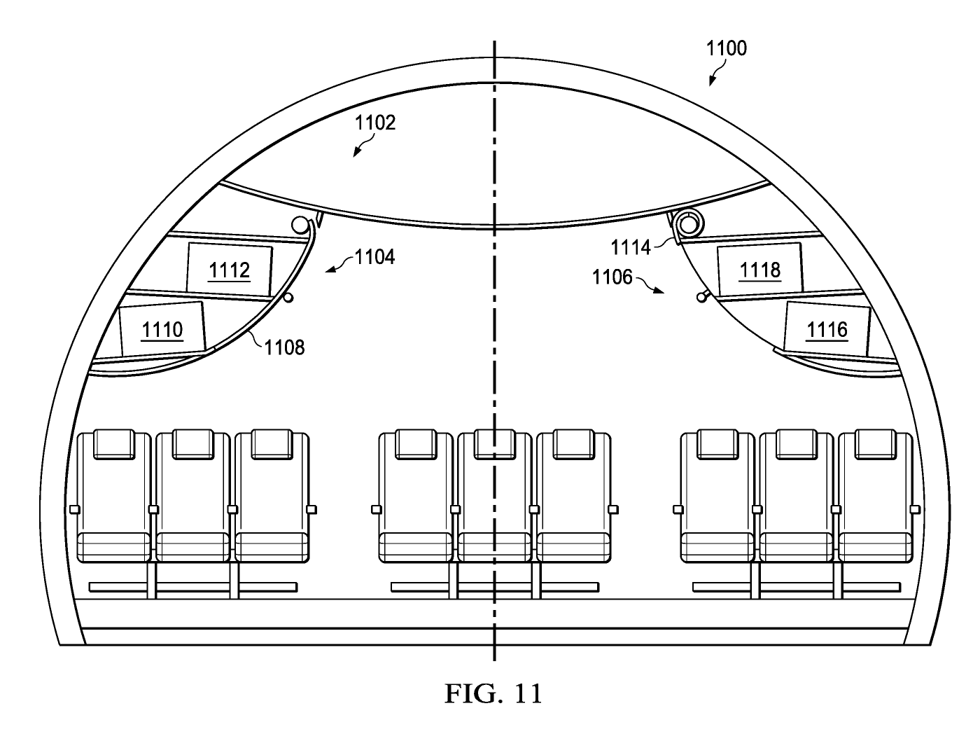

Turning now to FIG. 11, an illustration of a cross-sectional view of another implementation of overhead bins installed in a passenger cabin in an aircraft is depicted in accordance with an illustrative embodiment. Aircraft 1100 is a physical implementation of aircraft 201 of FIG. 2. In some illustrative examples, although aircraft 100 of FIG. 1 is depicted as having centerline bins, aircraft 100 may instead have the same design as aircraft 1100. In aircraft 1100, layout 1102 of overhead bin 1104 and overhead bin 1106 is substantially similar to overhead bin 902 and overhead bin 904 of FIG. 9. The differences between overhead bin 902 and overhead bin 904 of FIG. 9 and overhead bin 1104 and overhead bin 1106 are detailed below.

Overhead bin 1104 and overhead bin 1106 are depicted each with roll-up doors and hand rails. As depicted, first door 1108 moveably covers first storage volume 1110 and second storage volume 1112 of overhead bin 1104. As depicted, second door 1114 moveably covers third storage volume 1116 and fourth storage volume 1118. First door 1108 and second door 1114 may be substantially the same, however, first door 1108 is depicted in a closed position and second door 1114 in an open position. The controls for first door 1108 and second door 1114 may be positioned in any desirable location. Further, the controls may take any desirable mechanical or electrical form.

The different components shown in FIG. 1 and FIGS. 3-11 may be combined with components in FIG. 2, used with components in FIG. 2, or a combination of the two. Additionally, some of the components in FIG. 1 and FIGS. 3-11 may be illustrative examples of how components shown in block form in FIG. 2 can be implemented as physical structures.

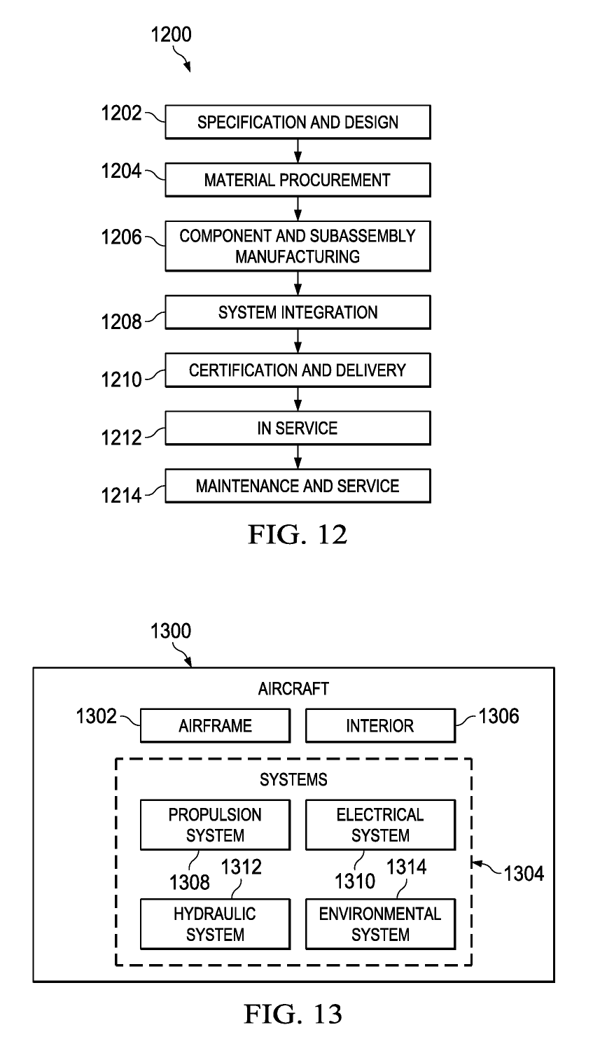

Illustrative embodiments of the present disclosure may be described in the context of aircraft manufacturing and service method 1200 as shown in FIG. 12 and aircraft 1300 as shown in FIG. 13. Turning first to FIG. 12, an illustration of a block diagram of an aircraft manufacturing and service method is depicted in accordance with an illustrative embodiment. During pre-production, aircraft manufacturing and service method 1200 may include specification and design 1202 of aircraft 1300 in FIG. 13 and material procurement 1204.

During production, component and subassembly manufacturing 1206 and system integration 1208 of aircraft 1300 takes place. Thereafter, aircraft 1300 may go through certification and delivery 1210 in order to be placed in service 1212. While in service 1212 by a customer, aircraft 1300 is scheduled for routine maintenance and service 1214, which may include modification, reconfiguration, refurbishment, or other maintenance and service.

Each of the processes of aircraft manufacturing and service method 1200 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 13, an illustration of a block diagram of an aircraft is depicted in which an illustrative embodiment may be implemented. In this example, aircraft 1300 is produced by aircraft manufacturing and service method 1200 in FIG. 12 and may include airframe 1302 with plurality of systems 1304 and interior 1306. Examples of systems 1304 include one or more of propulsion system 1308, electrical system 1310, hydraulic system 1312, and environmental system 1314. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 1200 of FIG. 12. One or more illustrative embodiments may be used during component and subassembly manufacturing 1206. For example, overhead bin 204 of FIG. 2 may be installed within aircraft 201 during component and subassembly manufacturing 1206 of FIG. 12. Further, replacements for overhead bin 204 of FIG. 2 may be installed within aircraft 201 during maintenance and service 1214 of FIG. 12.

In one illustrative example, a central storage compartment is positioned in a central crown section of the interior of a passenger cabin. The compartment has an upper and lower storage compartment each having a door for access. The passenger cabin also has a unitary cabin sidewall structure that extends from the cabin floor to the central storage compartment.

The illustrative embodiments provide a very large capacity bin system called “megabin”, for application in airliners. Passengers will be able to put bags such as roll-aboard bags in two stacked layers of bins, which can be either outboard or substantially at the airliner's centerline region. The illustrative embodiments provide bin capacity for passenger carry-on bags, e.g. for at least one roll-aboard bag per economy class passenger, combined with reduced aircraft weight and cost and integration with ceiling lines and lighting to provide a spacious feel to the passenger cabin, preferred aesthetics, an opportunity to have smooth surfaces for custom airline displays or advertising, good ergonomics and human factors for passengers and flight attendants, and available bins for use by shorter stature people.

The illustrative embodiments provide overhead bins that have improvements over conventional bins. The illustrative embodiments are shelf-type bins. Shelf-type bins may be lighter weight than prior-art bins, such as translating or pivot bins. For example, shelf-type bins have fewer components and therefore less weight. For example, shelf-type bins do not have systems to allow translation or rotation of the stowage bin. Further, shelf-type bins may have a reduced cost relative to prior-art pivot bins. The costs, including both recurring and nonrecurring, may be reduced by simplified manufacturing, reduced components, and less frequent maintenance or replacement due to simplified movement systems.

A shelf-type bin may be more rugged, durable, and damage-resistant than conventional pivot and translating bins. Further, a shelf-type bin is highly reliable and maintainable.

The illustrative examples present an airliner configured with a high capacity overhead stowage bin. The airliner has a cabin, an overhead stowage bin, a first shelf, a second shelf, first bin enclosure opening means, second bin enclosure opening means, first bin enclosure closing means, and second bin enclosure closing means. The airliner has a cabin capable of having installed more than one seat suitable for passenger seating certified for flight as well as taxi, takeoff and landing. The overhead stowage bin is located at a level above said seat. the first shelf of said overhead stowage bin is capable of supporting a first roller bag in a first volumetric space sufficient to accommodate said first roller bag. The second shelf is located above said first shelf and above said first volumetric space, said second shelf capable of supporting a second roller bag in a second volumetric space sufficient to accommodate said second roller bag. The first bin enclosure opening means is for enabling loading of said first roller bag from the cabin into said first volumetric space and second bin enclosure opening means is for enabling loading of said second roller bag from the cabin into said second volumetric space, when said first bin enclosure opening means and said second bin enclosure opening means are both in a fully open configuration. The first bin enclosure closing means is for enabling prevention of said first roller bag from falling into the cabin in the event of turbulence encountered by said airliner, when said first bin enclosure closing means is in a fully closed configuration. The second bin enclosure closing means is for enabling prevention of said second roller bag from falling into the cabin in the event of turbulence encountered by said airliner, when said second bin enclosure closing means is in a fully closed configuration.

In some illustrative examples, the airliner has said overhead stowage bin comprising a central stowage bin located above a central seat, said central seat being located between two longitudinal aisles of the airliner. In other illustrative examples, the overhead stowage bin comprises an outboard stowage bin located at a level above an outboard seat, said outboard seat being located between a longitudinal aisle of the airliner and a fuselage side wall of the airliner. In some examples, the more than one seat includes at least one of an economy-class seat, a tourist-class seat, a premium economy-class seat, a business-class seat, and a first-class seat.

In some illustrative examples, at least one of said first shelf and said second shelf slopes downward in an outward direction relative to the centerline of said airliner. In some illustrative examples, at least one of said first shelf and said second shelf slopes downward in an inward direction relative to the centerline of said airliner. In some illustrative examples, at least one of said first shelf and said second shelf has substantially no slope in an outward direction relative to the centerline of said airliner.

In some illustrative examples, the airliner further comprises friction reducing means for reducing frictional resistance to bag loading and unloading, said friction reducing means comprising at least one of a roller, a roller tray, a powered roller, a wheel, a low-friction shelf surface, a low-friction shelf liner, and a shelf surface incorporating polytetrafluoroethylene (PTFE) or equivalent low-friction surface panel elements.

In some illustrative examples, said first volumetric space is configured to accommodate said first roller bag in at least one of: a flat longitudinal orientation, an on-edge transverse orientation, a flat transverse orientation, and an on-edge longitudinal orientation. In some illustrative examples, said second volumetric space is configured to accommodate said second roller bag in at least one of: a flat longitudinal orientation, an on-edge transverse orientation, a flat transverse orientation, and an on-edge longitudinal orientation.

In some illustrative examples, at least one of said first bin enclosure opening means and said second bin enclosure opening means comprise roll up door means. In some illustrative examples, at least one of said first bin enclosure opening means and said second bin enclosure opening means comprise hinged door panel means. In some illustrative examples, at least one of said first bin enclosure opening means and said second bin enclosure opening means comprise sliding door means.

In some illustrative examples, said overhead storage bin is structurally connected to at least one railing that can be grasped by a hand of a person standing in a longitudinal aisle of said airliner. In some illustrative examples, said railing comprises a substantially continuous longitudinal railing. In some illustrative examples, said railing serves as lip means for bags to be loaded over and into a bin. In some illustrative examples, said railing is fitted with control means for controlling a bin door, operable by a person standing in a longitudinal aisle of said airliner. The control means may include at least one of a button, a switch, a latch, a control pad, a touchless control sensor, or any other desirable means for controlling a bin door.

Note that the illustrative examples as disclosed do not specify a particular roller bag size, and in fact varied airplane embodiments may be designed to accommodate varied roller bag sizes, and optionally have different bins sized for different bag sizes as well.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An overhead bin of an aircraft, comprising:
a substantially rigid first shelf;
bin sides connected to and extending upward from sides of the first shelf;
a substantially rigid second shelf above the first shelf, wherein the bin sides are connected to and extending upward from sides of the second shelf; and
a number of doors configured to provide access to the first shelf and the second shelf from a first direction.

2. The overhead bin of claim 1, wherein a volume between the first shelf and the second shelf is configured to receive a first number of roller bags, and wherein a volume between the second shelf and a top of the overhead bin is configured to receive a second number of roller bags.

3. The overhead bin of claim 1, wherein the number of doors includes at least one rolling door.

4. The overhead bin of claim 1, wherein the number of doors includes at least one sliding door.

5. The overhead bin of claim 1, wherein the number of doors comprises a first hinged door configured to provide access to the first shelf and a second hinged door configured to provide access to the second shelf.

6. The overhead bin of claim 1, wherein at least one of the first shelf or the second shelf slopes downward in an outward direction relative to a centerline of the aircraft.

7. The overhead bin of claim 1, wherein at least one of the first shelf or the second shelf slopes downward in an inward direction relative to a centerline of the aircraft.

8. The overhead bin of claim 1 further comprising:
a number of retainers associated with at least one of the first shelf or the second shelf, wherein the number of retainers is configured to discourage items from falling from the overhead bin.

9. The overhead bin of claim 1, wherein the second shelf is longer than the first shelf.

10. An overhead bin of an aircraft, comprising:
a first storage volume between a substantially rigid first shelf and a substantially rigid second shelf, the first storage volume having a first opening;
a second storage volume above the first storage volume, the second storage volume between the second shelf and a top of the overhead bin, the second storage volume having a second opening, wherein the first opening and the second opening are accessed from a same side of the aircraft; and
a first door moveably covering the first opening.

11. The overhead bin of claim 10 further comprising:
a second door moveably covering the second opening.

12. The overhead bin of claim 10, wherein the first door moveably covers the second opening.

13. The overhead bin of claim 10, wherein the overhead bin is a centerline bin.

14. The overhead bin of claim 13 further comprising:
a third storage volume with a third opening; and
a fourth storage volume with a fourth opening, wherein the third opening and the fourth opening are accessed from a side of the aircraft opposite the side of the aircraft accessing the first opening and the second opening.

15. The overhead bin of claim 10, wherein the first storage volume is configured to accommodate a roller bag in at least one of a flat longitudinal orientation, an on-edge transverse orientation, a flat transverse orientation or an on-edge longitudinal orientation.

16. The overhead bin of claim 10 further comprising:
a movement system associated with at least one of the first shelf or the second shelf, wherein the movement system is configured to reduce frictional resistance to bag loading and unloading to the overhead bin.

17. The overhead bin of claim 16, wherein the movement system comprises at least one of a roller, a roller tray, a powered roller, a wheel, a low-friction shelf surface, a low-friction shelf liner, or a shelf surface incorporating a low-friction material.

18. An aircraft having overhead bins positioned only in a centerline region of the aircraft, the aircraft comprising:
the overhead bins positioned only in the centerline region of the aircraft, wherein each overhead bin has a respective substantially rigid first shelf and a respective substantially rigid second shelf, wherein the respective second shelf is above the respective first shelf, and wherein the overhead bins are positioned substantially between two aisles of a passenger cabin of the aircraft.

19. The aircraft of claim 18, wherein a vertical clearance between a cabin floor and a bottom of the overhead bins is at least 58 inches.

20. The aircraft of claim 18, wherein a first storage volume between the respective first shelf and the respective second shelf is configured to accommodate a first number of roller bags, and wherein a second storage volume from the second shelf upward is configured to accommodate a second number of roller bags.

21. The aircraft of claim 18, wherein a set of respective overhead bins substantially aligned with a row of passenger seats is configured to accommodate at least one roller bag per seat in the row of passenger seats.
